(19) United States
(12) Patent Application Publication
(10) Pub. No.: US 2014/0341504 A1
(43) Pub. Date: Nov. 20, 2014

(54) OPTICAL CROSS-CONNECT SWITCH WITH CONFIGURABLE OPTICAL INPUT/OUTPUT PORTS

(71) Applicant: Mike J. Darling, San Jose, CA (US)

(72) Inventor: Mike J. Darling, San Jose, CA (US)

(73) Assignee: ALCATEL-LUCENT USA INC., Murray Hill, NJ (US)

(21) Appl. No.: 13/895,692

(22) Filed: May 16, 2013

(51) Int. Cl. G02B 6/35

(52) U.S. Cl. CPC G02B 6/356
USPC 385/17

(57) ABSTRACT

An optical cross-connect switch having a fiber collimator array (FCA), a MEMS mirror array, and a folded 4F relay system. Each optical fiber in the FCA can work as an input fiber or an output fiber. The MEMS mirror array has individually tiltable mirrors, each mapped to a respective one of the optical fibers in the FCA. The folded 4F relay system is configured to image the FCA onto itself such that, for each input fiber, the tip of the fiber is imaged onto the tip of the intended output fiber. The MEMS mirror array can select the output fiber by (i) tilting the mirror mapped to the input fiber to cause light redirected by that mirror to impinge on the mirror mapped to the output fiber and (ii) tilting the mirror mapped to the output fiber to cause light redirected by that mirror to couple into the output fiber.

### BACKGROUND

1. Field

The present disclosure relates to optical communication equipment and, more specifically but not exclusively, to optical switches.

2. Description of the Related Art

This section introduces aspects that may help facilitate a better understanding of the invention(s). Accordingly, the statements of this section are to be read in this light and are not to be understood as admissions about what is in the prior art or what is not in the prior art.

An optical cross-connect (OXC) switch is a device that is used, e.g., by telecommunications carriers, to switch optical signals in a fiber-optic network. A representative N×N OXC switch interconnects any of its N optical input ports to any of its N optical output ports in a one-to-one, optically transparent fashion. Due to the widespread use of optical-transport technologies, there is a market demand for OXC switches that have one or more, and possibly all, of the following characteristics: (i) low production cost; (ii) small form factor; (iii) high port count; (iv) high switching speed; and (v) low insertion loss.

### SUMMARY OF SOME SPECIFIC EMBODIMENTS

Disclosed herein are various embodiments of an optical cross-connect (OXC) switch having a fiber collimator array (FCA), a MEMS mirror array, and a folded 4F relay system. An optical fiber in the FCA can be configured to work as an input fiber or an output fiber. The MEMS mirror array has individually tiltable mirrors, with a tiltable mirror being mapped to a respective one of the optical fibers in the FCA. The folded 4F relay system is configured to image the FCA onto itself such that, for each “input” fiber (e.g., an optical fiber in the FCA that has been configured to operate as an input fiber), the tip of the fiber is imaged onto the tip of the intended “output” fiber (e.g., an optical fiber in the FCA that has been configured to operate as an output fiber). The MEMS mirror array can select the output fiber by (i) tilting the mirror mapped to the input fiber to cause light redirected by that mirror to impinge on the mirror mapped to the output fiber and (ii) tilting the mirror mapped to the output fiber to cause light redirected by that mirror to couple into the output fiber.

A representative OXC switch disclosed herein advantageously has (i) a relatively low production cost and a relatively small form factor due to a relatively small number of the constituent optical components; (ii) a relatively high port count, e.g., of about two hundred input/output ports; and (iii) a relatively low optical insertion loss due to the use of the 4F relay system.

According to one embodiment, provided is an apparatus comprising: an array of optical ports, wherein an optical port is configurable to operate as an input port or an output port; a static mirror; a first lens; and a MEMS mirror array having a plurality of individually tiltable mirrors, wherein a tiltable mirror is mapped to a respective one of the optical ports and is configured to: receive an optical signal from said respective one of the optical ports and redirect said optical signal through the first lens to the static mirror in a first configuration; and receive through the first lens an optical signal reflected by the static mirror and redirect said optical signal to said respective one of the optical ports in a second configuration.

In some embodiments of the above apparatus, the static mirror is positioned in a focal plane of the first lens.

In some embodiments of any of the above apparatus, the static mirror and the first lens are arranged to form a folded 4F relay system configured to image the array of optical ports onto itself such that an optical port in the array operating as an input port is imaged onto a selected optical port in the array operating as an output port.

In some embodiments of any of the above apparatus, for an optical port configured to operate as an input port, the MEMS mirror array is configurable to select an output port by: tilting the tiltable mirror mapped to the input port to cause the redirected optical signal to impinge on the tiltable mirror mapped to the output port; and tilting the tiltable mirror mapped to the output port to cause the redirected optical signal to couple into the output port.

In some embodiments of any of the above apparatus, the tiltable mirror mapped to the input port is configured to cause a redirected optical signal to impinge on the tiltable mirror mapped to the output port after passing through the first lens, being reflected by the static mirror, and again passing through the first lens.

In some embodiments of any of the above apparatus, a gap between neighboring tiltable mirrors in the MEMS mirror array has a size of approximately a diameter of the tiltable mirrors.

In some embodiments of any of the above apparatus, the array of optical ports comprises: an array of second lenses; and an array of optical fibers configured to match the array of second lenses, wherein an optical axis of an optical fiber is aligned with an optical axis of a matching second lens.

In some embodiments of any of the above apparatus, the second lenses in the array of second lenses are coplanar with each other; and a tip of the optical fiber in the matching array of optical fibers is positioned in a focal plane of a matching second lens.

In some embodiments of any of the above apparatus, the array of second lenses comprises a monolithic plate made of an optically transparent material and having a plurality of bulges on a first surface thereof, with each of said bulges functioning as a respective second lens; and a second surface of the monolithic plate opposite to the first surface is flat.

In some embodiments of any of the above apparatus, in the first configuration, said respective one of the optical ports is configured to operate as an input port; and in the second configuration, said respective one of the optical ports is configured to operate as an output port.

In some embodiments of any of the above apparatus, unbiased tiltable mirrors in the MEMS mirror array have respective reflecting surfaces being coplanar with each other.

In some embodiments of any of the above apparatus, a tiltable mirror in the MEMS mirror array is configured to rotate about a first rotation axis and about a second rotation axis that is non-collinear with the first rotation axis.

In some embodiments of any of the above apparatus, the apparatus further comprises a circuit board that hosts the MEMS mirror array together with electrical circuitry configured to generate drive signals for the MEMS mirror array to enable tilting of the tiltable mirrors therein.

In some embodiments of any of the above apparatus, the electrical circuitry is configured to generate the drive signals based on a control signal received from a controller that is external to the circuit board.

In some embodiments of any of the above apparatus, the apparatus further comprises a base, wherein the array of optical ports, the static mirror, the first lens, and the circuit board are fixedly attached to the base.

In some embodiments of any of the above apparatus, n optical ports in the array of optical ports are configured to operate as input ports, where n is a positive integer; m optical ports in the array of optical ports are configured to operate as output ports, where m is a positive integer greater than one; and the apparatus is configured to operate as an n×m optical cross-connect switch.

In some embodiments of any of the above apparatus, n<m.

In some embodiments of any of the above apparatus, n=m.

In some embodiments of any of the above apparatus, the apparatus is configured to operate as a switch bank having a plurality of optical cross-connect switches.

In some embodiments of any of the above apparatus, at least two of the optical cross-connect switches in said switch bank have different sizes.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical cross-connect (OXC) switch according to an embodiment of the disclosure;

FIG. 2 shows a top view of an optical device that can be used to implement the OXC switch shown in FIG. 1 according to an embodiment of the disclosure;

FIGS. 3A-3C schematically show optical-beam propagation in three representative configurations of the optical device shown in FIG. 2 according to an embodiment of the disclosure;

FIG. 4 shows a schematic front-side view of a MEMS mirror array that can be used in the optical device shown in FIG. 2 according to an embodiment of the disclosure;

FIGS. 5A-5B show perspective three-dimensional views of a fiber collimator array (FCA) that can be used in the optical device shown in FIG. 2 according to an embodiment of the disclosure;

FIGS. 6A-6B show perspective three-dimensional views of a printed-circuit-board (PCB) assembly 600 that can be used in the optical device shown in FIG. 2 according to an embodiment of the disclosure; and

FIGS. 7A-7C show perspective three-dimensional views of an OXC switch that has been constructed using the FCA shown in FIGS. 5A-5B and the PCB assembly shown in FIGS. 6A-6B according to an embodiment of the disclosure.

### DETAILED DESCRIPTION

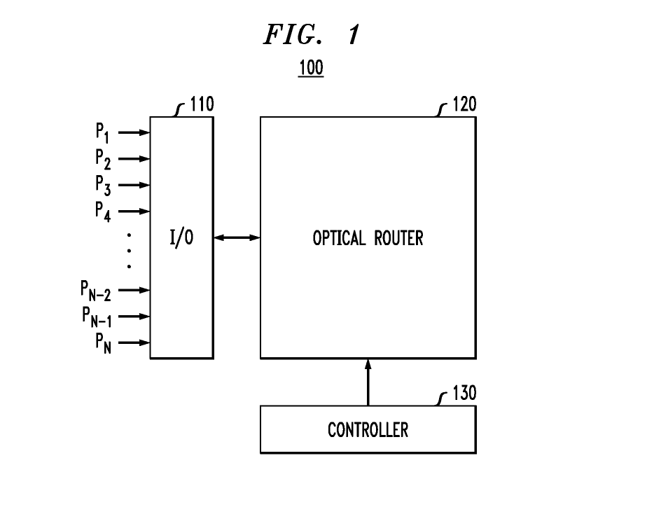

FIG. 1 shows a block diagram of an optical cross-connect (OXC) switch 100 according to an embodiment of the disclosure. OXC switch 100 comprises an array 110 of N optical input/output (I/O) ports P₁-P_{N}, an optical router 120, and a controller 130. Optical router 120 is optically coupled to I/O array 110 in a manner that enables the optical router to route an optical signal from any port Pᵢ to any port Pⱼ, where i≠j. Controller 130 operates to control the routing configuration of optical router 120, e.g., to provide desired pair-wise optical connections between ports P₁-P_{N} and to prevent optical-signal collisions in switch 100. When appropriate or necessary, controller 130 can configure optical router 120 to change its routing configuration, e.g., by changing at least one of the existing pair-wise optical connections between ports P₁-P_{N}.

Any of I/O ports P₁-P_{N} in array 110 can operate as an optical input port or an optical output port. For example, in one configuration of OXC switch 100, port Pᵢ can operate as an optical input port, while in an alternative configuration of OXC switch 100, the same port Pᵢ can operate as an optical output port. This I/O port re-configurability enables OXC switch 100 to be configurable to perform many different optical-switching functions, e.g., as further illustrated by the following examples corresponding to N=1024.

If a single I/O port in array 110 is configured to operate as an optical input port, while the remaining one thousand and twenty-three I/O ports are configured to operate as optical output ports, then OXC switch 100 functions as 1×1023 optical switch.

If n I/O ports in array 110 are configured to operate as optical input ports, while m I/O ports are configured to operate as optical output ports (where n+m≦1024), then OXC switch 100 functions as an n×m optical switch. The following relative values of n and m are possible: (i) n<m; (ii) n>m; and (iii) n=m.

In some configurations, OXC switch 100 can function as a switch bank. For example, with one of the I/O ports in array 110 unused, OXC switch 100 can be configured to function as a switch bank having three hundred and forty-one 1×2 optical switches (for a total of 341×(1+2)=1,063 used I/O ports). In another example, with thirty-two of the I/O ports in array 110 unused, OXC switch 100 can be configured to function as a switch bank having eight 1×128 optical switches (for a total of 8×(1+128)=1,032 used I/O ports). In yet another example, OXC switch 100 can be configured to function as a switch bank having thirty-two 16×16 optical switches (for a total of 32×(16+16)=1,064 used I/O ports). One of ordinary skill in the art will appreciate that other configurations are also possible, including configurations in which a resulting switch bank has optical switches of two or more different sizes.

In general, OXC switch 100 can be configured to function as a switch bank having K optical switches, with each optical switch being an nₖ×mₖ optical switch (where k=1, . . . , K), as long as the following condition is satisfied:

$${\sum }_{k = 1}^{K} ( {n}_{k} + {m}_{k} ) \leq N \qquad ( 1 )$$

In principle, the set of numbers consisting of all nₖ values and all mₖ values can have as many as 2K different integers. Also note that the condition expressed by Eq. (1) formally applies to the case of K=1 as well as to the case of K>1.

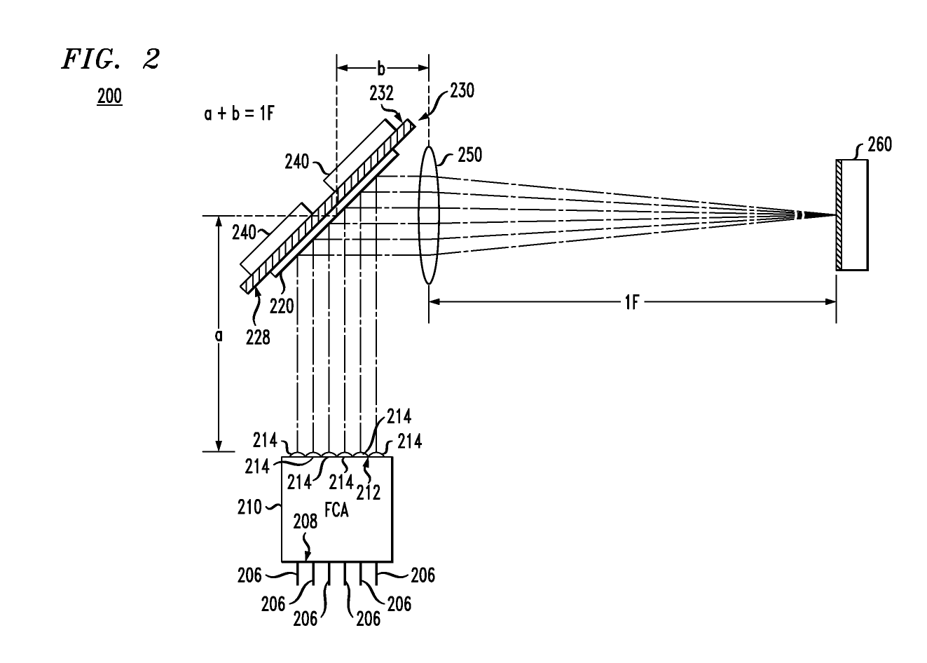

FIG. 2 shows a top view of an OXC switch 200 that can be used to implement OXC switch 100 according to an embodiment of the disclosure. The dashed lines in FIG. 2 show approximate optical ray traces in OXC switch 200.

OXC switch 200 has a fiber collimator array (FCA) 210 that operates as an array of optical I/O ports analogous to array 110 (FIG. 1). A backside 208 of FCA 210 has a plurality of optical fibers 206 arranged in a generally rectangular array, wherein each fiber 206 is approximately orthogonal to the backside surface. In the embodiment shown in FIG. 2, the fibers within the rectangular array are arranged in rows and columns. Only one such row of fibers 206 is visible in the projection shown in FIG. 2. There are six columns of fibers 206 in FCA 210, each column extending in the direction orthogonal to the plane of FIG. 2. One of ordinary skill in the art will understand that, in alternative embodiments, other fiber arrangements in FCA 210 are also possible.

A front side 212 of FCA 210 has a plurality of collimating lenses 214 arranged in a similar rectangular array and generally containing one lens 214 per one fiber 206. In one embodiment, lenses 214 are positioned with respect to optical fibers 206 such that (i) the tip (not explicitly shown in FIG. 2) of each optical fiber 206 is located approximately at the focal point of the corresponding lens 214 and (ii) the optical axis of the lens is aligned with the optical axis of the fiber in the vicinity of the tip. As used herein, the term “tip” is to be understood to relate to an end or extremity of the optical fiber. One of ordinary skill in the art will appreciate that this relative position of optical fibers 206 and lenses 214 serves to provide efficient coupling of light in and out the fibers. For example, when optical fiber 206 operates as an input fiber, a diverging light cone emitted from the fiber tip is transformed into a collimated beam after it passes through the corresponding lens 214. Similarly, when optical fiber 206 operates as an output fiber, a collimated light beam applied to lens 214 is transformed into a converging light cone that causes the light to couple through the fiber tip into the core of the corresponding optical fiber 206.

OXC switch 200 further has a MEMS mirror array 220, an imaging lens 250, and a static mirror 260 optically coupled to FCA 210 and to each other as indicated by the optical ray traces (dashed lines) in FIG. 2. MEMS mirror array 220 is located on a front side 228 of a printed-circuit-board (PCB) assembly 230. PCB assembly 230 also hosts a plurality of electronic components 240 that are illustratively shown in FIG. 2 as being located on a backside 232 of the PCB assembly. In one embodiment, electronic components 240 include electrical circuits configured to generate drive signals for the individual mirrors in MEMS mirror array 220 based on the control signal received from the switch controller, such as controller 130 (FIG. 1).

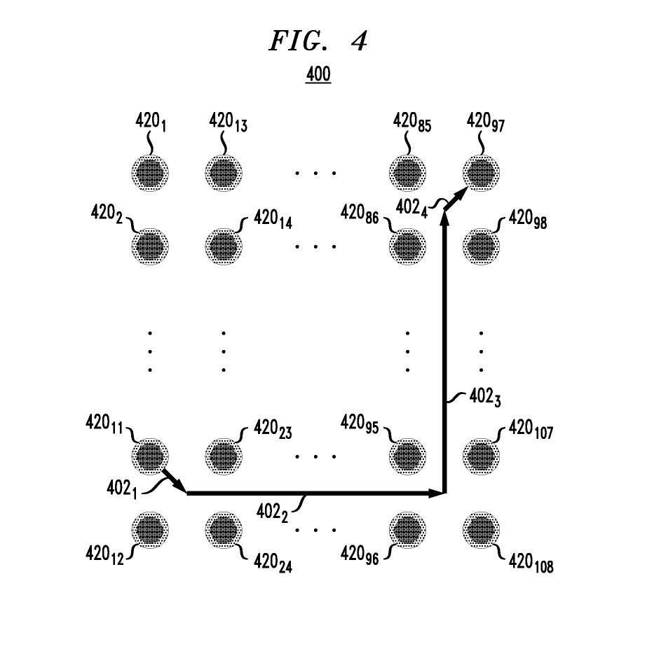

In one embodiment, MEMS mirror array 220 has one tiltable mirror per I/O port (e.g., fiber 206/lens 214 pairing) in FCA 210, with one-to-one mapping between the tiltable mirrors and the I/O ports. When the tiltable mirrors in MEMS mirror array 220 are unbiased (e.g., receive no drive voltages from circuits 240), the reflecting surfaces of the mirrors typically lie in the same (single) plane, e.g., parallel to front side 228 of PCB assembly 230. Each tiltable mirror in MEMS mirror array 220 is configured to rotate about two non-collinear (e.g., mutually orthogonal) axes, which enables two-dimensional beam steering across front side 212 of FCA 210, e.g., as further described below in reference to FIG. 4. Exemplary MEMS devices that can be used in OXC switch 200 as MEMS mirror array 220 are disclosed, e.g., in U.S. Pat. Nos. 7,126,250, 6,859,300, and 6,300,619, all of which are incorporated herein by reference in their entirety.

Imaging lens 250 and static mirror 260 are positioned in OXC switch 200 to form a folded 4F relay system, where F is the focal length of lens 250. More specifically, the reflecting surface of static mirror 260 is positioned to be approximately in a focal plane of imaging lens 250, as indicated in FIG. 2 by the double-headed arrow showing the distance between the imaging lens and the static mirror. Front side 212 of FCA 210 is positioned to be approximately in another focal plane of imaging lens 250, as indicated in FIG. 2 by the two double-headed arrows labeled a and b (where a+b=F). The combined length of these two double-headed arrows represents the effective distance between the imaging lens and the front side of the FCA. The folded 4F relay system operates to effectively image FCA 210 onto itself such that the tip of an input fiber 206 is imaged onto the tip of the corresponding output fiber 206. This type of imaging helps to keep fiber-to-fiber insertion losses in OXC switch 200 at relatively low levels.

In operation, a collimated optical beam exiting from an input port in FCA 210 impinges onto a corresponding (e.g., “first”) mirror in MEMS mirror array 220. The first mirror reflects the collimated optical beam toward imaging lens 250. After passing through imaging lens 250, the collimated optical beam impinges onto static mirror 260 and is reflected back toward imaging lens 250. After passing through imaging lens 250 the second time, the collimated optical beam impinges onto another (e.g., “second”) mirror in MEMS mirror array 220. The second mirror then reflects the collimated optical beam toward FCA 210. The tilt angle of the first mirror determines which of the mirrors in MEMS mirror array 220 becomes the second mirror, and the identity of the second mirror can be changed by changing the tilt angle of the first mirror. The tilt angle of the second mirror is set to offset the beam's incidence angle caused by the rotation angle of the first mirror and to properly line up the reflected collimated optical beam with the optical axis of the lens 214 and optical fiber 206 of the corresponding output port in FCA 210.

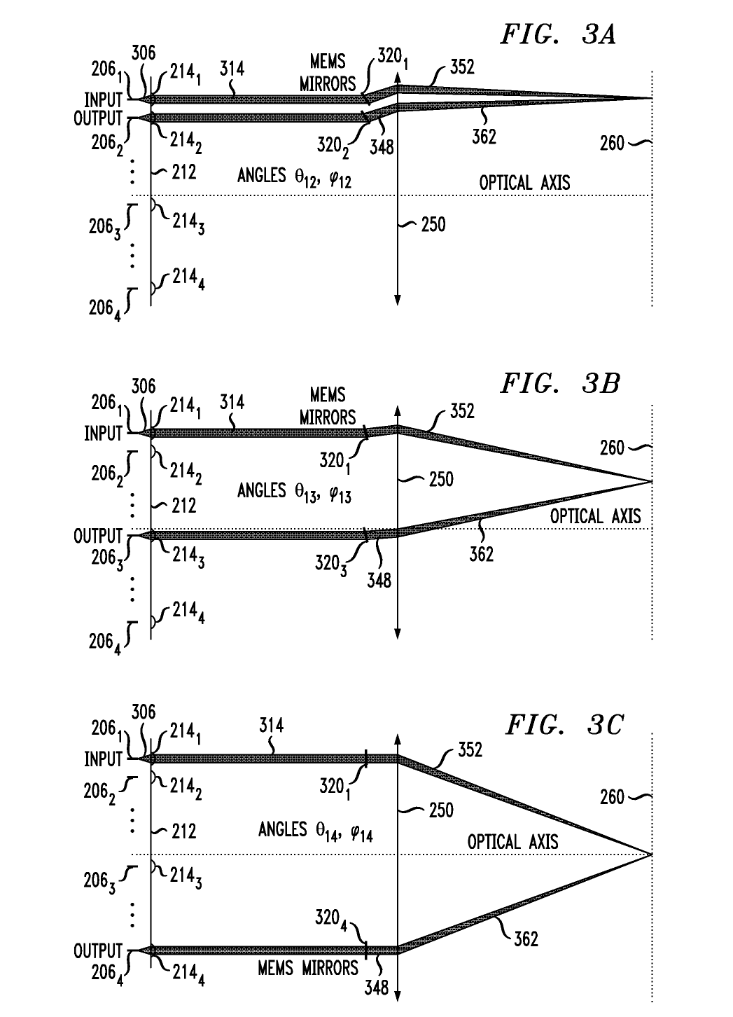

FIGS. 3A-3C schematically show optical-beam propagation in three representative configurations of OXC switch 200 (FIG. 2) according to an embodiment of the disclosure. More specifically, in the configurations shown in FIGS. 3A-3C, optical fiber 206₁ serves as an input fiber, and optical fibers 206₂, 206₃, and 206₄ serve as respective output fibers. Due to the general reversibility of light propagation, the optical-beam traces shown in FIGS. 3A-3C also represent the three additional respective configurations in which the input/output roles of the fibers are swapped. In particular, the optical-beam traces shown in FIG. 3A also represent the configuration in which optical fiber 206₂ serves as an input fiber while optical fiber 206₁ serves as an output fiber. The optical-beam traces shown in FIG. 3B also represent the configuration in which optical fiber 206₃ serves as an input fiber while optical fiber 206₁ serves as an output fiber. The optical-beam traces shown in FIG. 3C also represent the configuration in which optical fiber 206₄ serves as an input fiber while optical fiber 206₁ serves as an output fiber.

Referring to FIG. 3A, a diverging light cone 306 emitted from the tip of optical fiber 206₁ is collimated by collimating lens 214₁ to form a collimated optical beam 314. Collimated optical beam 314 then impinges onto a mirror 320₁ in MEMS mirror array 220. Mirror 320₁, which is oriented at angle θ_{1,2} with respect to the normal to front side 228 (not shown in FIG. 3A, see FIG. 2), reflects collimated optical beam 314 toward imaging lens 250. After passing through imaging lens 250, reflected optical beam 314 is transformed into a converging light cone 352. After being reflected by static mirror 260 back toward imaging lens 250, converging light cone 352 becomes a diverging light cone 362. After passing through imaging lens 250, light cone 362 is collimated to form a collimated optical beam 348 that impinges onto a mirror 320₂ in MEMS mirror array 220. Mirror 320₂, which is oriented at angle φ_{1,2} with respect to the normal to front side 228, reflects collimated optical beam 348 toward collimating lens 214₂. Collimating lens 214₂ then focuses the received reflected optical beam on the tip of optical fiber 206₂, thereby coupling the optical energy of the optical beam into the core of that fiber.

Tilt angle θ_{1,2} of mirror 320₁ is set to cause collimated optical beam 348 to impinge onto mirror 320₂. Tilt angle φ_{1,2} of mirror 320₂ is set to cause the reflected optical beam 348 to be approximately parallel to the effective optical axis of the 4F relay system and impinge onto collimating lens 214₂ for proper coupling into the core of optical fiber 206₂.

The optical-beam propagation schemes shown in FIGS. 3B and 3C are similar to that shown in FIG. 3A, except that the pertinent mirrors 320 in these schemes are oriented at different respective angles. For example, in the configuration shown in FIG. 3B, mirrors 320₁ and 320₂ are oriented at tilt angles θ_{1,3} and φ_{1,3}, respectively. Tilt angle θ_{1,3} is set to cause collimated optical beam 348 to impinge onto mirror 320₃. Tilt angle φ_{1,3} is set to cause the reflected optical beam 348 to be approximately parallel to the effective optical axis of the 4F relay system and impinge onto collimating lens 214₃ for proper coupling into the core of optical fiber 206₃. In the configuration shown in FIG. 3C, mirrors 320₁ and 320₄ are oriented at tilt angles θ_{1,4} and φ_{1,4}, respectively. Tilt angle θ_{1,4} is set to cause collimated optical beam 348 to impinge onto mirror 320₄. Tilt angle φ_{1,4} is set to cause the reflected optical beam 348 to be approximately parallel to the effective optical axis of the 4F relay system and impinge onto collimating lens 214₄ for proper coupling into the core of optical fiber 206₄.

For the relative positions of optical fibers 206₁-206₄ indicated in FIGS. 3A-3C, the mirror tilt angles have the following relative values: θ_{1,2}>θ_{1,3}>θ_{1,4} and φ_{1,2}>φ_{1,3}>φ_{1,4}. For a fully symmetric position of optical fibers 206₁ and 206₄ with respect to the effective optical axis of the 4F relay system, θ_{1,4}≈φ_{1,4}≈0. One of ordinary skill in the art will understand that appropriate values of tilt angle θ selected from the range [θ_{1,4},θ_{1,2}] and appropriate values of tilt angle φ selected from the range [φ_{1,4},φ_{1,2}] can be used to couple light from optical fiber 206₁ to any other optical fiber 206 in FCA 210.

FIG. 4 shows a schematic front-side view of a MEMS mirror array 400 that can be used as MEMS mirror array 220 (FIG. 2) according to an embodiment of the disclosure. MEMS mirror array 400 comprises one hundred and eight mirrors labeled 420₁-420₁₀₈ arranged in a planar rectangular array having twelve rows and nine columns. The smallest gap between two neighboring mirrors 420 in MEMS mirror array 400 is about the same as the approximate lateral size (e.g., between 70% and 130% of the diameter) of an individual mirror. This characteristic of MEMS mirror array 400 enables hitless switching from one output fiber to another, e.g., as further explained below.

As used herein, the term “hitless switching” refers to a process of reconfiguring the corresponding OXC switch (such as OXC switch 200, FIG. 2) in a manner that substantially prevents the optical signal that is being switched from coupling into (or “hitting on”) unintended I/O ports of the OXC switch without having to turn OFF or block that optical signal. One of ordinary skill in the art will appreciate that hitless switching can be beneficial in that it helps to reduce inter-channel crosstalk in the corresponding OXC switch.

In the example shown in FIG. 4, an optical signal is being switched from port 11 to port 97, when both of these ports are configured to operate as output ports. For the sake of clarity, we will assume that the input port for this optical signal is port 1. Thus, in the first (initial) state of the OXC switch, the optical signal is routed from port 1 to port 11. In the second (final) state of the OXC switch, the optical signal is routed from port 1 to port 97.

In one embodiment, to transition from the first state to the second state, the tilt angle of mirror 420₁ is changed from θ_{1,11} to θ_{1,97} in four discrete rotations to cause the light spot corresponding to the optical signal to move along a hitless trajectory 402 consisting of four linear segments 402₁-402₄. More specifically, the first rotation of mirror 420₁ causes the light spot to move along linear segment 402₁ away from mirror 420₁₁ and into the inter-mirror space between the eleventh and twelfth rows of mirrors in MEMS mirror array 400. The second rotation of mirror 420₁ causes the light spot to move along linear segment 402₂ in the inter-mirror space between the eleventh and twelfth rows of mirrors. The third rotation of mirror 420₁ causes the light spot to move along linear segment 402₃ in the inter-mirror space between the eighth and ninth columns of mirrors in MEMS mirror array 400. Finally, the fourth rotation of mirror 420₁ causes the light spot to move along linear segment 402₄ from the inter-mirror space between the eighth and ninth columns of mirrors and onto mirror 420₉₇. One of ordinary skill in the art will understand that hitless trajectory 402 is merely exemplary and that, in alternative embodiments, other hitless trajectories (not necessarily having polygonal-chain shapes) across the front side of MEMS mirror array 400 can similarly be implemented.

The tilt angle of mirror 420₉₇ can be changed to angle φ_{1,97}, e.g., during the time period when the light spot corresponding to the optical signal is travelling along trajectory 402. In this manner, optical-signal hits on I/O ports other than I/O port 97 in the corresponding FCA can substantially be avoided.

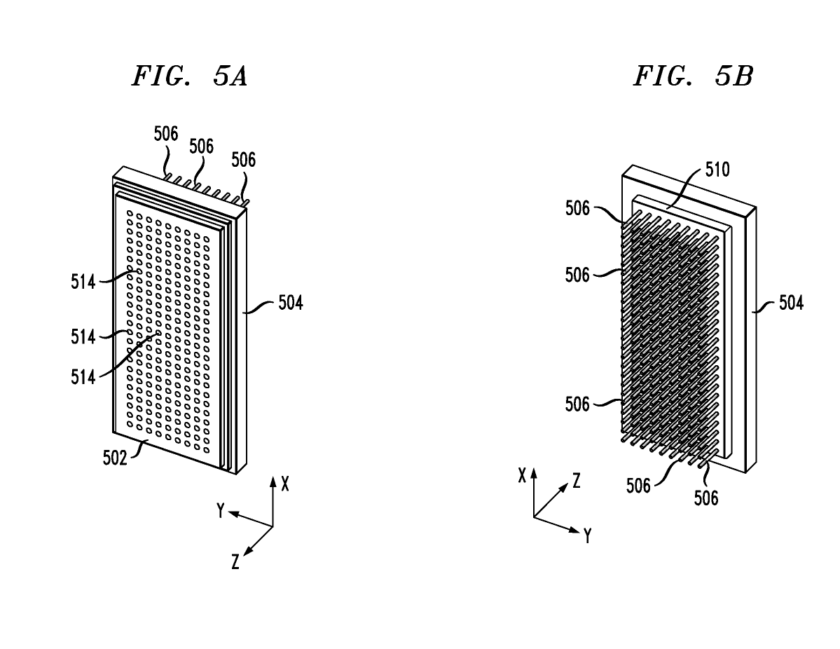

FIGS. 5A-5B show perspective three-dimensional views of an FCA 500 that can be used as FCA 210 (FIG. 2) according to an embodiment of the disclosure. More specifically, FIG. 5A shows a front-side view of FCA 500. FIG. 5B shows a backside view of FCA 500. The coordinate-axis (XYZ) triad shown in each of FIGS. 5A-5B further clarifies the relative orientation of the two views.

Referring to FIG. 5A, the front side of FCA 500 has a monolithic plate 502 made of an optically transparent material, e.g., glass. The front side of plate 502 has been shaped to form a 9×24 array of collimating (e.g., plano-convex) lenses 514, which appear as bulges on the otherwise flat surface thereof. The backside of plate 502 (not directly visible in the view shown in FIG. 5A) is flat. The backside of plate 502 is attached to the front side of a rectangular support frame 504.

Referring to FIG. 5B, the backside of FCA 500 has a 9×24 array of optical fibers 506 having the same pitch as the 9×24 array of collimating lenses 514. Each optical fiber 506 protrudes through a respective hole in a fiber substrate 510. Fiber substrate 510 is attached to the backside of support frame 504 such that (i) each optical fiber 506 is lined up with the optical axis of the corresponding one of collimating lenses 514 and (ii) the tips of the optical fibers are placed approximately at the focal plane of the collimating lenses.

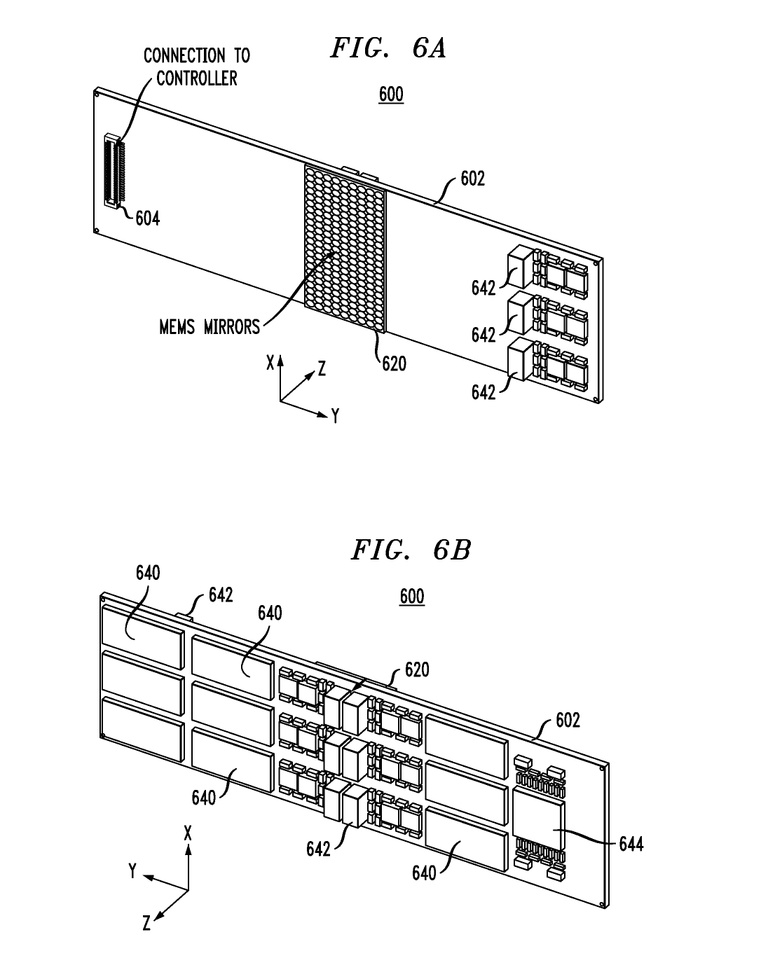

FIGS. 6A-6B show perspective three-dimensional views of a PCB assembly 600 that can be used to implement PCB assembly 230 (FIG. 2) according to an embodiment of the disclosure. More specifically, FIG. 6A shows a front-side view of PCB assembly 600. FIG. 6B shows a backside view of PCB assembly 600. The coordinate-axis (XYZ) triad shown in each of FIGS. 6A-6B further clarifies the relative orientation of the two views.

PCB assembly 600 comprises a printed circuit board 602 that hosts (i) a MEMS mirror array 620, (ii) a plurality of electrical circuits, such as circuits 640, 642, and 644, and (iii) a plurality of individual circuit components (e.g., capacitors, resistors, etc.). MEMS mirror array 620 is mounted on the front side of printed circuit board 602 as indicated in FIG. 6A. Some of the electrical circuits and individual circuit components are mounted on the font side of printed circuit board 602, while the remaining electrical circuits and individual circuit components are mounted on the backside of the printed circuit board, as indicated in FIGS. 6A-6B. PCB assembly 600 also has an electrical connector 604 (see FIG. 6A) configured to supply electrical power to the electrical circuits and individual circuit components therein and also to serve as an I/O interface for the PCB assembly. In one embodiment, circuits 640, 642, and 644 contain appropriate circuitry for generating drive signals for the individual mirrors in MEMS mirror array 620 based on the control signals received through electrical connector 604 from the external controller, such as controller 130 (FIG. 1).

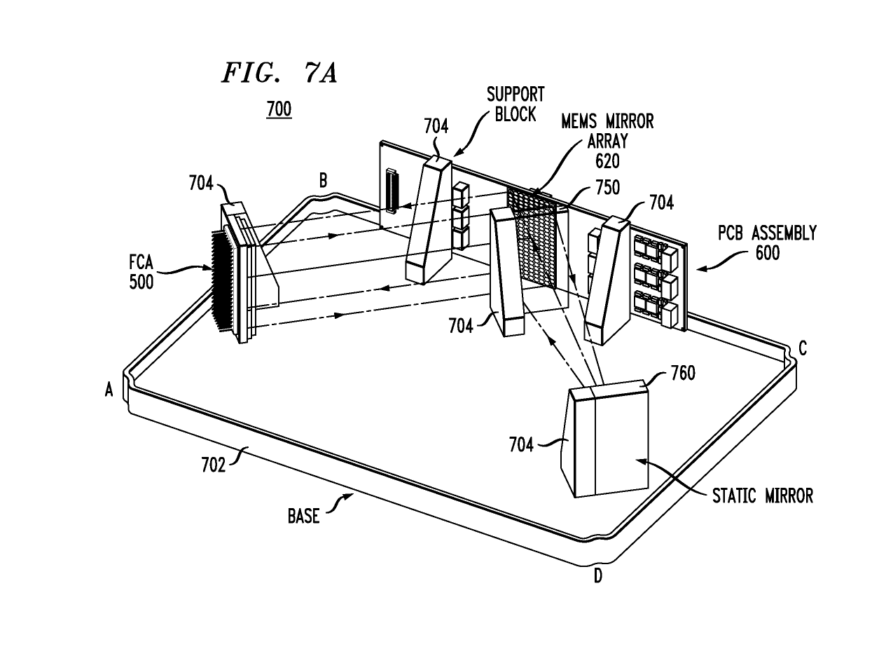

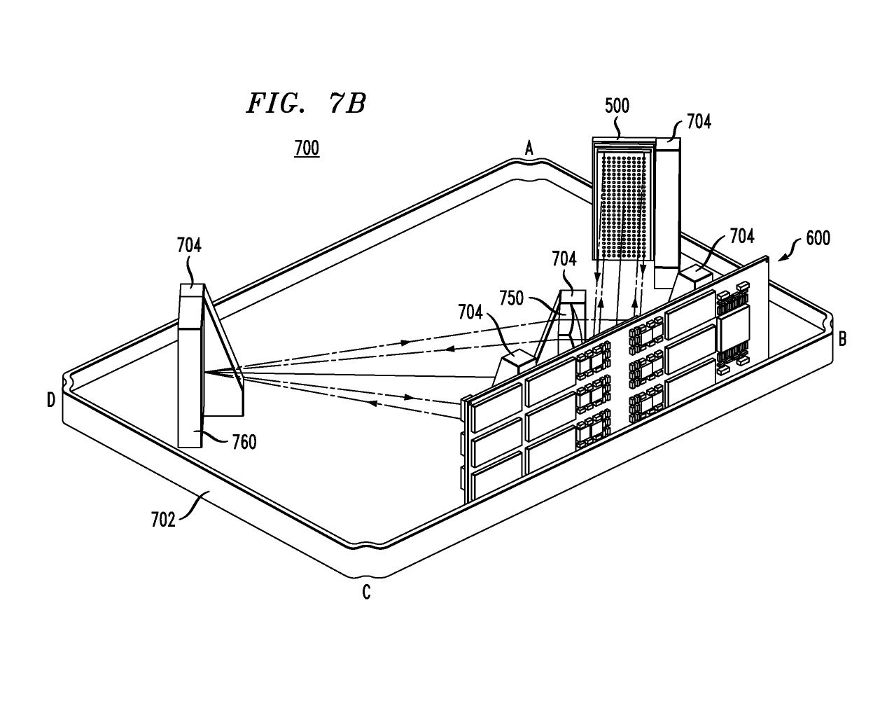

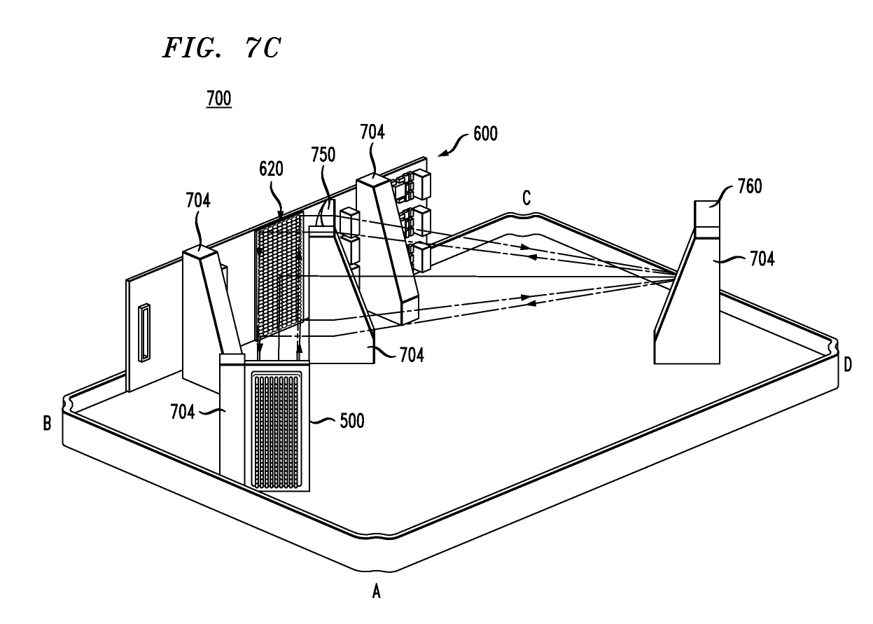

FIGS. 7A-7C show perspective three-dimensional views of an OXC switch 700 that has been constructed using FCA 500 (FIGS. 5A-5B) and PCB assembly 600 (FIGS. 6A-6B) according to an embodiment of the disclosure. OXC switch 700 includes a substantially rectangular base 702 on which other components of the switch are mounted. In each of FIGS. 7A-7C, the four corners of base 702 are labeled A, B, C, and D to indicate the relative orientation of the three views.

In addition to FCA 500 and PCB assembly 600, OXC switch 700 includes an imaging lens 750 and a static mirror 760 that are functionally analogous to imaging lens 250 and static mirror 260, respectively (see FIG. 2). Imaging lens 750 is a spherical lens having a rectangular cross-section, which helps to reduce lateral dimensions of the lens and simplifies the process of attaching the lens to base 702. In one embodiment, imaging lens 750 has a focal length of about 75 mm. Static mirror 760 is similarly implemented using a rectangular block of material, one side of which is coated by a metal film that serves as the mirror's reflecting surface.

FCA 500, PCB assembly 600, imaging lens 750, and static mirror 760 are appropriately optically aligned with respect to each other and fixed in place using five approximately triangular support blocks 704. More specifically, one side of support block 704 is fixedly attached (e.g., glued) to the corresponding component of OXC switch 700, and another side of the support block is fixedly attached to base 702. Three support blocks 704 (one per component) are used for attaching FCA 500, imaging lens 750, and static mirror 760 to base 702. The two remaining support blocks 704 are used for attaching PCB assembly 600 to base 702 as indicated in FIGS. 7A-7C.

For illustration purposes, FIGS. 7A-7C also show optical ray traces corresponding to two exemplary optical signals routed through OXC switch 700. More specifically, one of these optical signals is routed from the I/O port located in the upper left corner of FCA 500 to the I/O port located in the lower right corner of the FCA (see FIG. 7B). The other optical signal is routed from the I/O port located in the lower left corner of FCA 500 to the I/O port located in the upper right corner of the FCA (also see FIG. 7B).

While this invention has been described with reference to illustrative embodiments, this description is not intended to be construed in a limiting sense.

For example, note that embodiments of OXC switches disclosed herein do not perform wavelength de-multiplexing and do not employ spectrally dispersive elements, such as diffraction gratings. As a result, an optical WDM signal will be routed through the OXC switch as a WDM bundle, without any change in the signal's WDM content. More specifically, if an optical WDM signal applied to an input port of the OXC switch has a particular set of WDM components, then it emerges at an intended output port of the OXC switch with the same (unaltered) set of WDM components.

In an exemplary embodiment, due to a one-to-one mapping between the tiltable mirrors of the MEMS mirror array and the optical I/O ports of the FCA, any of the optical ports operates by being directly optically coupled to and thereby directly optically communicating with the respective one of the tiltable mirrors, regardless of whether the optical port is configured to operate as an input port or as an output port. More specifically, if the optical port is configured to operate as an input port, then the optical port sends optical signals directly to that respective one of the tiltable mirrors. If the optical port is configured to operate as an output port, then the optical port receives optical signals directly from the same respective one of the tiltable mirrors.

Various modifications of the described embodiments, as well as other embodiments of the invention, which are apparent to persons skilled in the art to which the invention pertains are deemed to lie within the principle and scope of the invention as expressed in the following claims.

For the purposes of this specification, a MEMS device is a device having two or more parts adapted to move relative to one another, where the motion is based on any suitable interaction or combination of interactions, such as mechanical, thermal, electrical, magnetic, optical, and/or chemical interactions. MEMS devices are fabricated using micro- or smaller fabrication techniques (including nano-fabrication techniques) that may include, but are not necessarily limited to: (1) self-assembly techniques employing, e.g., self-assembling monolayers, chemical coatings having high affinity to a desired chemical substance, and production and saturation of dangling chemical bonds and (2) wafer/material processing techniques employing, e.g., lithography, chemical vapor deposition, patterning and selective etching of materials, and treating, shaping, plating, and texturing of surfaces. The scale/size of certain elements in a MEMS device may be such as to permit manifestation of quantum effects. Examples of MEMS devices include, without limitation, NEMS (nano-electromechanical systems) devices, MOEMS (micro-opto-electromechanical systems) devices, micromachines, microsystems, and devices produced using microsystems technology or microsystems integration.

Although embodiments of the present invention have been described in the context of using MEMS devices, the alternative embodiments of the present invention can in principle be realized at any suitable scale, including scales larger than the micro-scale.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Throughout the detailed description, the drawings, which are not to scale, are illustrative only and are used in order to explain, rather than limit the invention. The use of terms such as height, length, width, top, bottom, front, back is strictly to facilitate the description of the invention and is not intended to limit the invention to a specific orientation. For example, height does not imply only a vertical rise limitation, but is used to identify one of the three dimensions of a three-dimensional structure as shown in some of the figures.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required, unless such term is accompanied by an indentifying adverb such as “directly” or “immediately”, such as “directly connected”. Conversely, the terms “directly coupled,” “directly connected,” etc., imply the absence of such additional elements.

The present invention(s) may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

What is claimed is:

1. An apparatus comprising:
an array of optical ports, wherein an optical port is configurable to operate as an input port or an output port;
a static mirror;
a first lens; and
a MEMS mirror array having a plurality of individually tiltable mirrors, wherein a tiltable mirror is mapped to a respective one of the optical ports and is configured to:
receive an optical signal from said respective one of the optical ports and redirect said optical signal through the first lens to the static mirror in a first configuration; and
receive through the first lens an optical signal reflected by the static mirror and redirect said optical signal to said respective one of the optical ports in a second configuration.

2. The apparatus of claim 1, wherein the static mirror is positioned in a focal plane of the first lens.

3. The apparatus of claim 2, wherein the static mirror and the first lens are arranged to form a folded 4F relay system configured to image the array of optical ports onto itself such that an optical port in the array operating as an input port is imaged onto a selected optical port in the array operating as an output port.

4. The apparatus of claim 1, wherein, for an optical port configured to operate as an input port, the MEMS mirror array is configurable to select an output port by:
tilting the tiltable mirror mapped to the input port to cause the redirected optical signal to impinge on the tiltable mirror mapped to the output port; and
tilting the tiltable mirror mapped to the output port to cause the redirected optical signal to couple into the output port.

5. The apparatus of claim 4, wherein the tiltable mirror mapped to the input port is configured to cause a redirected optical signal to impinge on the tiltable mirror mapped to the output port after passing through the first lens, being reflected by the static mirror, and again passing through the first lens.

6. The apparatus of claim 1, wherein a gap between neighboring tiltable mirrors in the MEMS mirror array has a size of approximately a diameter of the tiltable mirrors.

7. The apparatus of claim 1, wherein the array of optical ports comprises:
an array of second lenses; and
an array of optical fibers configured to match the array of second lenses, wherein an optical axis of an optical fiber is aligned with an optical axis of a matching second lens.

8. The apparatus of claim 7, wherein:
the second lenses in the array of second lenses are coplanar with each other; and
a tip of the optical fiber in the matching array of optical fibers is positioned in a focal plane of a matching second lens.

9. The apparatus of claim 7,
wherein the array of second lenses comprises a monolithic plate made of an optically transparent material and having a plurality of bulges on a first surface thereof, with each of said bulges functioning as a respective second lens; and
wherein a second surface of the monolithic plate opposite to the first surface is flat.

10. The apparatus of claim 1, wherein:
in the first configuration, said respective one of the optical ports is configured to operate as an input port; and
in the second configuration, said respective one of the optical ports is configured to operate as an output port.

11. The apparatus of claim 1, wherein unbiased tiltable mirrors in the MEMS mirror array have respective reflecting surfaces being coplanar with each other.

12. The apparatus of claim 1, wherein a tiltable mirror in the MEMS mirror array is configured to rotate about a first rotation axis and about a second rotation axis that is non-collinear with the first rotation axis.

13. The apparatus of claim 1, further comprising a circuit board that hosts the MEMS mirror array together with electrical circuitry configured to generate drive signals for the MEMS mirror array to enable tilting of the tiltable mirrors therein.

14. The apparatus of claim 13, wherein the electrical circuitry is configured to generate the drive signals based on a control signal received from a controller that is external to the circuit board.

15. The apparatus of claim 13, further comprising a base, wherein the array of optical ports, the static mirror, the first lens, and the circuit board are fixedly attached to the base.

16. The apparatus of claim 1, wherein:
n optical ports in the array of optical ports are configured to operate as input ports, where n is a positive integer;
m optical ports in the array of optical ports are configured to operate as output ports, where m is a positive integer greater than one; and
the apparatus is configured to operate as an n×m optical cross-connect switch.

17. The apparatus of claim 16, wherein n<m.

18. The apparatus of claim 16, wherein n=m.

19. The apparatus of claim 1, wherein the apparatus is configured to operate as a switch bank having a plurality of optical cross-connect switches.

20. The apparatus of claim 19, wherein at least two of the optical cross-connect switches in said switch bank have different sizes.
